(19) United States
(12) Patent Application Publication
(10) Pub. No.: US 2025/0235953 A1
(43) Pub. Date: Jul. 24, 2025

(54) CURRENT COLLECTOR WELDING SYSTEM FOR SECONDARY BATTERY CELL AND METHOD THEREOF

(71) Applicant: HANA TECHNOLOGY CO., LTD., Yongin-si (KR)

(72) Inventors: Dea Ro LEE, Suwon-si (KR); Young Suk KIM, Yongin-si (KR); Dong Hyun YUN, Yongin-si (KR); Tae Bong OH, Yongin-si (KR); Jae Hyuk JEON, Yongin-si (KR); Jong Seok WOO, Yongin-si (KR)

(21) Appl. No.: 19/009,324

(22) Filed: Jan. 3, 2025

(30) Foreign Application Priority Data
Jan. 24, 2024 (KR) 10-2024-0011071
Jul. 26, 2024 (KR) 10-2024-0099041
Jul. 31, 2024 (KR) 10-2024-0101788
Aug. 6, 2024 (KR) 10-2024-0104293

(51) Int. Cl. B23K 26/064; B23K 26/082

(52) U.S. Cl. CPC B23K 26/064; B23K 26/082

(57) ABSTRACT

A current collector welding system for a secondary battery cell and a method thereof are proposed. The current collector welding system for a secondary battery cell is configured to track and laser-weld a current collecting plate rotated together with a rotating plate when the current collecting plate is laser-welded with a jelly roll, thereby improving the process efficiency.

### CROSS REFERENCE TO RELATED APPLICATION

The present application claims priority to Korean Patent Application No. 10-2024-0011071, filed Jan. 24, 2024, Korean Patent Application No. 10-2024-0104293, filed Aug. 6, 2024, Korean Patent Application No. 10-2024-0099041, filed Jul. 26, 2024, Korean Patent Application No. 10-2024-0101788, filed Jul. 31, 2024, in the Korean Intellectual Property Office, the entire contents of which is incorporated herein for all purposes by this reference.

### BACKGROUND OF THE INVENTION

### Field of the Invention

The present disclosure relates to a current collector welding system for a secondary battery cell and a method thereof. More particularly, the present disclosure relates to a current collector welding system for a secondary battery cell and a method thereof, the welding system having improved process efficiency by tracking and laser welding a current collecting plate rotated together with a rotating plate when the current collecting plate is laser-welded with a jelly roll.

### Description of the Related Art

In general, a battery is configured to supply electrical energy by including a cathode (positive electrode) and an anode (negative electrode) separated from each other by a separator, and an electrolyte that enables ion transfer between the two electrodes.

Batteries are divided into primary batteries (ordinary batteries) that are discarded after one use, and secondary batteries that can be reused through charging. Recently, the demand for secondary batteries has been rapidly increasing due to the spread of portable electronic devices such as cell phones, laptops, and PDAs. Accordingly, secondary batteries with gradually improved performance are being mass-produced.

Meanwhile, a lithium ion secondary battery can be completed by manufacturing a positive electrode and a negative electrode by applying a positive electrode active material and a negative electrode active material to a metal foil (e.g., lithium foil), inserting a separator between the two electrodes and winding the electrodes with the separator to manufacture a jelly roll, inserting the manufactured jelly roll into a cylindrical or rectangular metal container, filling the container with an electrolyte, and sealing the container.

After the manufacturing process of the jelly roll, a welding method using a laser beam is used to attach the current collecting plate, through which electrons flow smoothly in the anode-cathode electrochemical reaction, to an upper portion and/or a lower portion of the jelly roll.

In addition, a general welding device that must be equipped with units for transporting secondary batteries, welding, and removing completed batteries cannot have an efficient layout overall, and an overall size thereof is increased, making the welding device unnecessarily large. Therefore, it is not easy to place a plurality of welding devices in a limited space. Therefore, it may be difficult to perform the laser welding process simultaneously by the plurality of welding devices within a set period of time.

In addition, in the laser welding process between the rotating current collecting plate and the jelly roll, it is common to perform the process after stopping the current collecting plate and the jelly roll at a position corresponding to a laser welder. Therefore, the welding performance time can be relatively long. This is a major factor in reducing process efficiency.

Furthermore, a rotary welder is used in laser welding between the current collecting plate and the jelly roll. The rotary welder refers to a welding machine that performs welding by placing a workpiece to be welded on a turntable that rotates by a motor and then fixing the workpiece with a chuck or the like. A general rotary welder includes a turntable configured to be rotated, a rotary motor for rotating the turntable, and a reducer, and a workpiece to be welded is fixed on the turntable by a chuck or the like.

When a workpiece to be welded is welded using the rotary welder, the turntable does not always maintain a constant rotational. In other words, the turntable must perform constant, acceleration, or deceleration rotation at each time point or section during rotation.

FIG. 1 is a graph illustrating the acceleration rotation and the deceleration rotation of an existing turntable during laser welding by using the existing turntable.

Referring to FIG. 1, as an example, the turntable is operated by going through an acceleration section from a stationary state, and after time t1, performing a constant rotational while maintaining a constant speed value (=rotation speed set value), and then after time t2, going through a deceleration section and stopping. In other words, the turntable does not perform always constant rotational motion.

As described above, the turntable may have different rotation speeds at each time point. When laser welding is automatically performed on a workpiece fixed to a chuck or the like without considering the change in rotation speed, it is not easy to weld the workpiece according to a desired pattern. A laser welding pattern at each time point is calculated by considering the constant motion of the turntable. However, when the turntable does not perform constant motion, there is a problem in which the ideal welding pattern is not tracked when the workpiece is welded according to the calculated welding pattern. The problem can be a major factor in reducing welding uniformity.

To solve the above-mentioned problems, the inventor of the present disclosure discloses a welding method using an improved current collector welding system for a secondary battery.

### Documents of Related Art

Korean Patent No. 10-1900403 “Apparatus of aligning a cylindrical battery and a welding apparatus comprising the same”

### SUMMARY OF THE INVENTION

Accordingly, the present disclosure has been made keeping in mind the above problems occurring in the related art, an objective of the present disclosure is to provide a current collector welding system for a secondary battery cell and a method thereof, when laser welding with a current collecting plate fixed to a jelly roll, the current collector welding system tracking the current collecting plate rotated together with a rotating plate and emitting a laser beam, thereby improving the process efficiency.

Another objective of e present disclosure is to provide a current collector welding system for a secondary battery cell and a method thereof, the welding system being configured to correct welding pattern information to correspond to acceleration motion and/or deceleration motion of a rotating plate to allow a current collecting plate fixed at one portion of a fixing jig to be precisely welded.

Yet another objective of the present disclosure is to provide a current collector welding system for a secondary battery cell and a method thereof, the welding system being configured to measure the height of a current collecting plate fixed to a jelly roll, before the current collecting plate is welded on the jelly roll, to automatically correct the height of a laser output unit to correspond to the height of the current collecting plate, thereby improving welding uniformity of the current collecting plate to the jelly roll.

Still another objective of the present disclosure is to provide a current collector welding system for a secondary battery cell and a method thereof, the welding system being configured to control an laser output unit to emit a laser beam when a rotation angle of a fixing jig from a reference location specified by a location detection unit is a preset value, thereby precisely specifying a laser beam emission time point.

Still another objective of the present disclosure is to provide a current collector welding system for a secondary battery cell and a method thereof, in which a sensor dog detection unit detects a sensor dog rotated with a rotating plate to specify a laser beam emission time point of a laser output unit to prevent the occurrence of time delay between a time point when a current collecting plate is inserted into the laser output unit and a time point when a control unit controls laser beam emission.

Still another objective of the present disclosure is to provide a current collector welding system for a secondary battery cell and a method thereof, when using a sensor dog and a sensor dog detection unit, the welding system being configured not to specify a current location of a rotating plate through an encoder to prevent a loss of a current location of the rotating plate due to encoder defects or communication noise.

The present disclosure may be realized by embodiments having following configuration in order to achieve the above-described objectives.

According to an embodiment of the present disclosure, a current collector welding system for a secondary battery cell includes: a rotating plate rotated by a driving device; a fixing jig coupled to the rotating plate and fixing a current collecting plate on a jelly roll; a laser output unit spaced apart from the rotating plate and configured to laser welding the current collecting plate to one portion of the inserted jelly roll; and a control unit controlling the laser output unit, wherein the laser output unit may track and weld the current collecting plate rotated with the rotating plate.

According to another embodiment of the present disclosure, the current collector welding system for a secondary battery cell is characterized in that the laser output unit may laser-weld the current collecting plate rotated with the rotating plate within a predetermined angle range when the current collecting plate is welded on the jelly roll.

According to another embodiment of the present disclosure, the current collector welding system for a secondary battery cell is characterized in that the laser output unit may include: a light source apparatus emitting a laser beam; a first scanner controlling a first directional displacement of the laser beam emitted from the light source apparatus; and a second scanner controlling a second directional displacement of the laser beam reflected from the first scanner.

According to another embodiment of the present disclosure, the current collector welding system for a secondary battery cell is characterized in that the first scanner may include: a first reflective mirror provided to be rotatable to reflect a laser beam emitted from the light source apparatus; and a first driving unit connected to the first reflective mirror and rotating the first reflective mirror.

According to another embodiment of the present disclosure, the current collector welding system for a secondary battery cell is characterized in that the second scanner may include: a second reflective mirror provided to be rotatable to reflect the laser beam reflected from the first scanner; and a second driving unit connected to the second reflective mirror and rotating the second reflective mirror.

According to another embodiment of the present disclosure, the current collector welding system for a secondary battery cell is characterized to further include an encoder disposed adjacent to the rotating plate; and a scanner board specifying a rotation speed of the rotating plate on the basis of information acquired from the encoder.

According to another embodiment of the present disclosure, the current collector welding system for a secondary battery cell is characterized in that the laser output unit may include: a light source apparatus emitting a laser beam; a first scanner controlling a first directional displacement of the laser beam emitted from the light source apparatus; and a second scanner controlling a second directional displacement of the laser beam reflected from the first scanner, and the control unit may include: a pattern storage module storing welding pattern information for the current collecting plate; a correction module calculating corrected welding pattern information, which is time series information, on the basis of the welding pattern information by considering a rotation speed of the rotating plate; and an angle adjustment module controlling the first scanner and the second scanner to follow the welding pattern information corrected by the correction module.

According to another embodiment of the present disclosure, the current collector welding system for a secondary battery cell is characterized in that the correction module may be configured to further correct laser density at each time point on the basis of the rotation speed of the rotating plate specified by the scanner board.

According to another embodiment of the present disclosure, the current collector welding system for a secondary battery cell is characterized to further include an encoder specifying a rotation speed of the rotating plate; and a location detection unit specifying a rotation angle between a reference location at a specific time point and the fixing jig on the basis of information acquired from the encoder.

According to another embodiment of the present disclosure, the current collector welding system for a secondary battery cell is characterized in that the control unit may include an emission control module, and when the preset rotation angle is formed between the reference location at the specific time point and the fixing jig, the emission control module may control the laser output unit to emit the laser beam.

According to another embodiment of the present disclosure, the current collector welding system for a secondary battery cell is characterized to further include a height detection unit located on the rotating plate, and detecting a height of the current collecting plate fixed by the fixing jig, wherein the laser output unit may be configured to be raised and lowered, and the control unit may include: a Z-axis correction module correcting a height of the laser output unit on the basis of the height information of the current collecting plate detected by the height detection unit.

According to another embodiment of the present disclosure, the current collector welding system for a secondary battery cell is characterized in that the height detection unit may be a displacement sensor.

According to another embodiment of the present disclosure, the current collector welding system for a secondary battery cell is characterized in that the Z-axis correction module may correct a Z-axis coordinate value of the laser output unit when the height of the current collecting plate exceeds an upper limit value and a lower limit value having ±permissible value based on a reference value.

According to another embodiment of the present disclosure, the current collector welding system for a secondary battery cell is characterized to further include a sensor dog disposed on the rotating plate; and a sensor dog detection unit fixed to one side and detecting the sensor dog rotated with the rotating plate, wherein the control unit may include: an emission control module controlling the laser output unit to emit a laser beam when the sensor dog detection unit detects the sensor dog.

According to another embodiment of the present disclosure, the current collector welding system for a secondary battery cell is characterized in that the sensor dog may be disposed to be spaced apart from another sensor dog at a substantially equal angle in a circumferential direction.

According to another embodiment of the present disclosure, the current collector welding system for a secondary battery cell is characterized in that each sensor dog may be disposed a portion of the corresponding fixing jig or a portion adjacent to the fixing jig. According to another embodiment of the present disclosure, a current collector welding system for a secondary battery cell may include: a rotating plate rotated by a driving device; a plurality of fixing jigs coupled to the rotating plate, fixing a current collecting plate on a jelly roll, and spaced apart from each other in a circumferential direction; a laser output unit spaced apart from the rotating plate, and laser welding the current collecting plate at one portion of the jelly roll that is inserted with rotation of the rotating plate; and a control unit controlling the laser output unit, wherein the laser output unit may track and weld the current collecting plate, which is rotated with the rotating plate, within a predetermined angle range, and the rotating plate may maintain a rotated state thereof during welding of the current collecting plate.

According to another embodiment of the present disclosure, the current collector welding system for a secondary battery cell is characterized in that each fixing jig may include: a fixing unit coupled to the rotating plate and fixing the jelly roll inserted; a raising and lowering means controlling raising and lowering of a pressure unit; and the pressure unit vacuum-adsorbing the inserted current collecting plate and fixing the current collecting plate on the jelly roll.

According to another embodiment of the present disclosure, the current collector welding system for a secondary battery cell is characterized in that the pressure unit may include a through hole providing a passage through which a laser beam emitted from the laser output unit reaches the current collecting plate.

According to another embodiment of the present disclosure, the current collector welding system for a secondary battery cell is characterized to further include an encoder disposed adjacent to the rotating plate; and a scanner board specifying a rotation speed of the rotating plate on the basis of information acquired from the encoder, wherein the control unit may include: a pattern storage module storing welding pattern information about the current collecting plate; a correction module calculating corrected welding pattern information on the basis of the welding pattern information by considering a rotation speed of the rotating plate; and an angle adjustment module controlling the first scanner and the second scanner to follow the welding pattern information corrected by the correction module, and the scanner board counts a pulse value of the encoder and specifies a rotation speed of the rotating plate.

The present disclosure has the following effects with the above-described configuration.

According to the present disclosure, during laser welding with the current collecting plate fixed to the jelly roll, the welding system tracks the current collecting plate rotated together with the rotating plate and emits a laser beam to improve the process efficiency.

Furthermore, according to the present disclosure, the welding pattern information is corrected to correspond to acceleration and/or deceleration of the rotating plate so that the current collecting plate fixed to one portion of the fixing jig can be precisely welded.

Furthermore, according to the present disclosure, the welding system measures the height of the current collecting plate fixed to the jelly roll, before the current collecting plate is welded on the jelly roll, to automatically corrects the height of the laser output unit to correspond to the height of the current collecting plate, so that welding uniformity of the current collecting plate to the jelly roll can be improved.

Furthermore, according to the present disclosure, the welding system is configured to control the laser output unit to emit a laser beam when a rotation angle of the fixing jig from a reference location specified by the location detection unit is a preset value, so that a laser beam emission time point can be precisely specified.

Furthermore, according to the present disclosure, the sensor dog detection unit detects the sensor dog rotated with the rotating plate to specify a laser beam emission time point of the laser output unit, so that it is possible to prevent the occurrence of time delay between a time point when the current collecting plate is inserted into the laser output unit and a time point when the control unit controls laser beam emission.

Furthermore, according to the present disclosure, when using the sensor dog and the sensor dog detection unit, the welding system is configured not to specify a current location of the rotating plate through the encoder, so that it is possible to prevent loss of a current location of the rotating plate due to encoder defects or communication noise.

Meanwhile, it should be added that even if the effects are not explicitly mentioned herein, the effects described in the following specification expected by the technical features of the present disclosure and their potential effects can be treated as if they were described in the specifications of the present disclosure.

### BRIEF DESCRIPTION OF THE DRAWINGS

FIG. 1 is a graph illustrating the acceleration rotation and the deceleration rotation of an existing turntable during laser welding by using the existing turntable;

FIG. 2 is a perspective view illustrating a current collector welding system for a secondary battery cell according to an embodiment of the present disclosure;

FIG. 3 is a concept view illustrating the current collector welding system for a secondary battery cell according to FIG. 2;

FIG. 4 is a block diagram illustrating the current collector welding system for a secondary battery cell according to FIG. 2;

FIG. 5 is an enlarged view illustrating a fixing jig according to FIG. 2; FIG. 6 is a reference view illustrating a sensor dog and a sensor dog detection unit according to FIG. 3;

FIG. 7 is a concept view illustrating a laser output unit according to FIG. 2; FIG. 8 is a block diagram illustrating a control unit according to FIG. 2; FIG. 9 is a flowchart illustrating a method for welding a current collecting plate for a secondary battery cell according to an embodiment of the present disclosure;

FIG. 10 is a concept view illustrating step S10 according to FIG. 9;

FIG. 11 is a concept view illustrating step S20 according to FIG. 9;

FIG. 12 is a concept view illustrating step S60 according to FIG. 9;

FIG. 13 is a concept view illustrating step S80 according to FIG. 9.

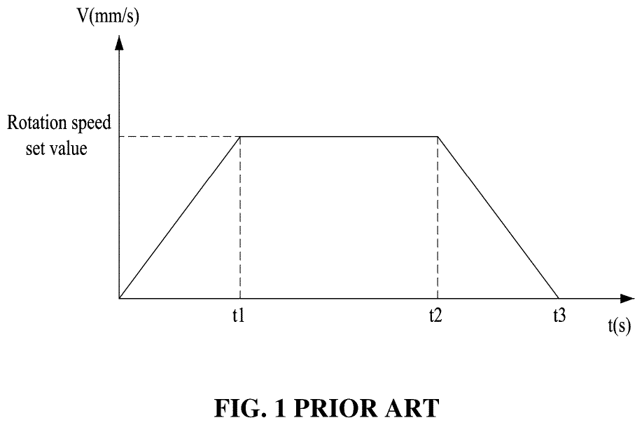

### DETAILED DESCRIPTION OF THE INVENTION

Hereinbelow, embodiments of the present disclosure will be described in detail with reference to accompanying drawings. The embodiments of the present disclosure may be modified in various forms, and the scope of the present disclosure should not be construed as being limited to the following embodiments, but should be construed based on the matters described in the claims. In addition, these embodiments are only provided for reference in order to more completely explain the present disclosure to those of ordinary skill in the art.

As used herein, the singular forms “a”, “an” and “the” are intended to include the plural forms as well, unless the context clearly indicates otherwise. It will be further understood that the terms “comprise” and/or “comprising” when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, it should be noted that when one component (or layer) is described as being disposed on another component (or layer), one component may be disposed directly on another component, or another component(s) or layer(s) may be located between the components. In addition, when one component is expressed as being directly disposed on or above another component, no other component(s) are located between the components. Moreover, being located on “top”, “upper”, “lower”, “top”, “bottom” or “one (first) side” or “side” of a component means a relative positional relationship.

Hereinbelow, it will be understood that when an element is referred to as being “coupled” or “connected” to another element, it can be directly coupled or connected to the other element or indirectly coupled or connected thereto with intervening elements.

A jelly roll 93 which is a term used herein refers to a configuration in which a positive electrode, a negative electrode, and a separator are wound into a cylindrical shape and then fixed with a tape, for example, to be function as actual batteries.

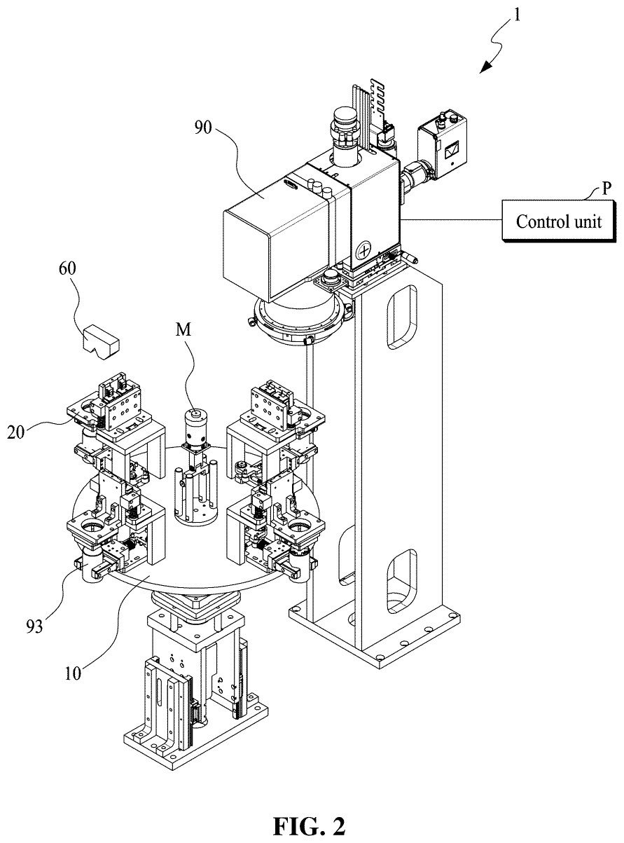

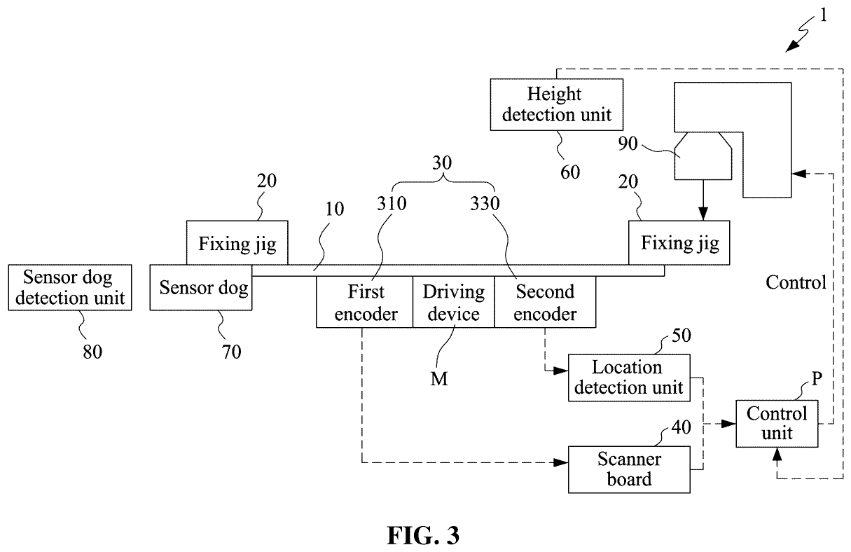

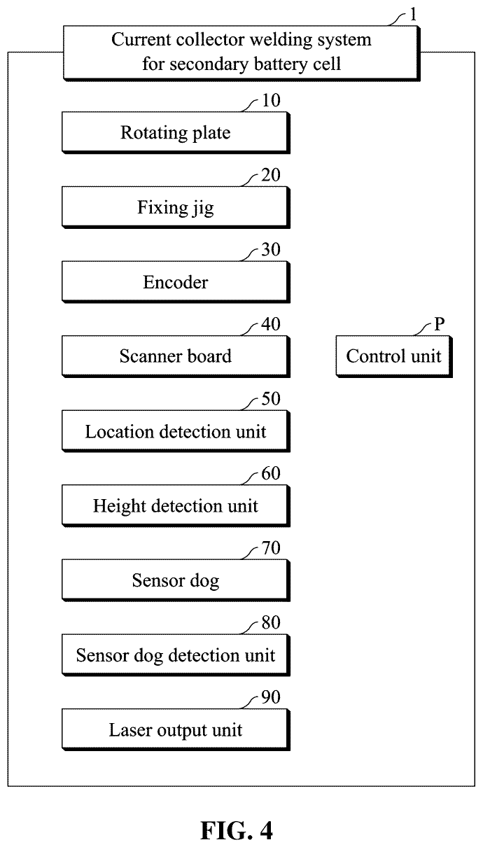

FIG. 2 is a perspective view illustrating a current collector welding system for a secondary battery cell according to an embodiment of the present disclosure. FIG. 3 is a concept view illustrating the current collector welding system for a secondary battery cell according to FIG. 2. FIG. 4 is a block diagram illustrating the current collector welding system for a secondary battery cell according to FIG. 2.

Hereinbelow, a current collector welding system 1 for a secondary battery cell according to an embodiment of the present disclosure will be described in detail with reference to accompanying drawings.

Hereinbelow, a cylindrical secondary battery will be described for convenience of description, but the application range of the present disclosure is not limited to a specific type of secondary battery, and it should be noted that the present disclosure is applied to a different type of secondary battery such as a rectangular secondary battery, etc.

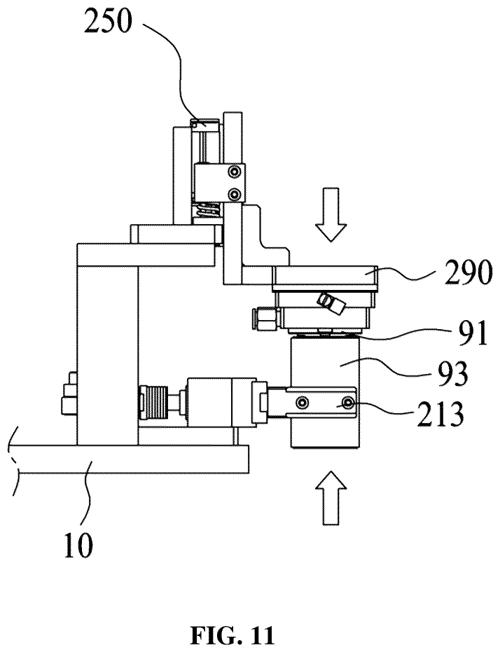

Referring to FIGS. 2 to 4, the present disclosure relates to a current collector welding system 1 for a secondary battery cell. More particularly, the present disclosure relates to a current collector welding system 1 for a secondary battery cell, and the current collector welding system 1 tracks a current collecting plate 91 rotated with the rotating plate 10 when the current collecting plate 91 (referring to FIG. 11) is laser-welded on the jelly roll 93 and emits a laser beam thereto, thereby improving the entire process efficiency. In other words, in the embodiment of the present disclosure, since the current collector welding system of the present disclosure performs tracking and welding to the current collecting plate 91 rotated with the rotating plate 10, the current collector welding system is characterized in that there is unnecessary to include a process of stopping the rotating plate 10 at a preset location for laser welding.

To this end, the current collector welding system 1 for a secondary battery cell may include the rotating plate 10, a fixing jig 20, an encoder 30, a scanner board 40, a location detection unit 50, a height detection unit 60, a sensor dog 70, a sensor dog detection unit 80, a laser output unit 90, and a control unit P.

The rotating plate 10 is rotated by a driving device M. For example, the rotating plate 10 has a disc shape and is rotatable horizontally under the control of the driving device M, and its shape is not particularly limited. Furthermore, the rotating plate 10 may remain the rotation state or the stop state when the laser output unit 90 to be described later welds the current collecting plate 91 to the jelly roll 93, and the former state is preferable. In the former state, for example, when the current collecting plate 91 is welded on the jelly roll 93, the rotating plate 10 may remain in the rotation state without stopping. For example, the rotating plate 10 may be rotated using a cam method, using a driving force of the driving device M such as a rotary motor. Hereinbelow, it should be understood that the “driving device M” is a rotary motor and/or a cam structure. Furthermore, the rotating plate 10 is preferably configured to be raisable and lowerable vertically.

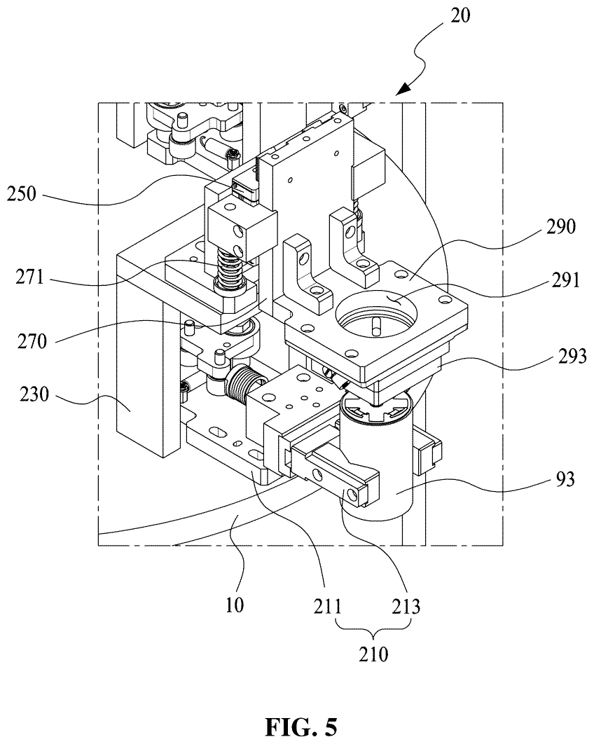

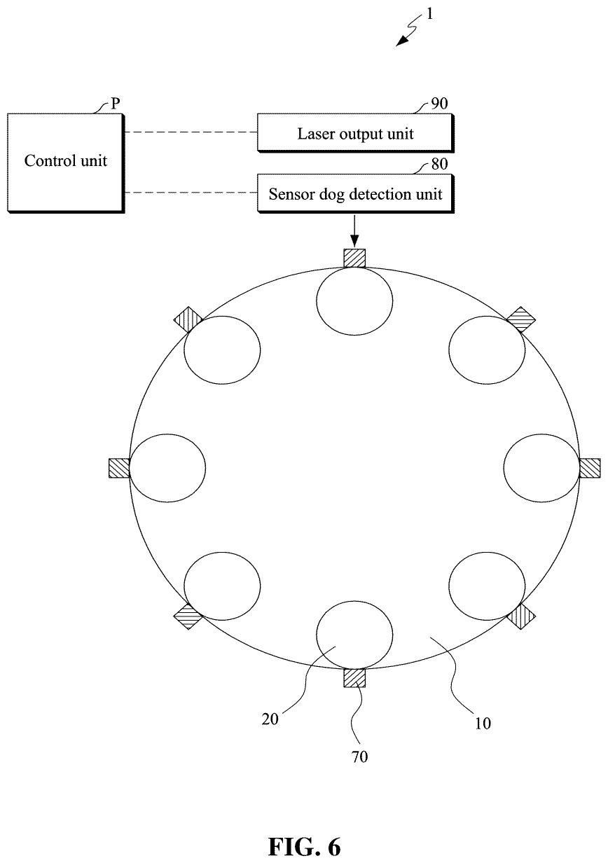

FIG. 5 is an enlarged view illustrating the fixing jig according to FIG. 2.

Referring to FIGS. 2 to 5, the fixing jig 20 is coupled to the rotating plate 10 to fix the current collecting plate 91 and the jelly roll 93. By this configuration, the current collecting plate 91 and the jelly roll 93 may be rotated together when the rotating plate 10 is rotated. Furthermore, the fixing jig 20 presses and fixes the current collecting plate 91 and the jelly roll 93 at regular locations so that the current collecting plate 91 and the jelly roll 93 are easily welded. Furthermore, the fixing jig 20 is preferably formed in a plurality of fixing jigs spaced apart from each other at predetermined intervals in a circumferential direction on the rotating plate 10. For example, preferably, total 8 fixing jigs 20 are spaced apart from each other by 45° in the circumferential direction, but the scope of the present disclosure is not limited to the value range.

Furthermore, each fixing jig 20 may include a fixing unit 210, a guide member 230, a raising and lowering means 250, a connection member 270, and a pressure unit 290.

The fixing unit 210 is coupled to the rotating plate 10 and fixes the supplied jelly roll 93. For example, the fixing unit 210 may grip an outer surface of the jelly roll 93. To this end, the fixing unit 210 may include a seating plate member 211 and a gripper unit 213.

The seating plate member 211 is formed on an upper surface of the rotating plate 10 and is coupled to the gripper unit 213. For example, the seating plate member 211 may have a plate form structure but is not limited particularly. However, it should be noted that the seating plate member 211 is not an essential component of the present disclosure.

The gripper unit 213 is configured to grip or release the jelly roll 93. One portion of the gripper unit 213 is disposed on the seating plate member 211, for example, on an upper surface of the seating plate member 211.

The guide member 230 is configured to be coupled to the rotating plate 10 and the raising and lowering means 250, and for example, it has a plate structure. For example, the guide member 230 extends upward, and as an example, an upper portion thereof may be coupled to the raising and lowering means 250 and a lower portion may be coupled to the rotating plate 10.

The raising and lowering means 250 is coupled, at one portion thereof, to the guide member 230, and may control the pressure unit 290 so that the pressure unit 290 is raised and lowered. The raising and lowering means 250 may include a hydraulic cylinder or a pneumatic cylinder and include a known separate driving means, and there is no separate limitation.

The connection member 270 connects the raising and lowering means 250 and the pressure unit 290 to each other. For example, a first portion of the connection member 270 may be coupled to the raising and lowering means 250, and a second portion of the connection member 270 may be coupled to the pressure unit 290. Therefore, with driving of the raising and lowering means 250, the connection member 270 may be raised or lowered. Furthermore, the connection member 270 may include an elastic means 271.

One portion of the elastic means 271 is in contact with the connection member 270. The elastic means 271 is contracted or expands during the raising or lowering of the pressure unit 290, thereby adjusting the connection member 270 so that the connection member 270 is easily recovered to an original position by a recovery force during contraction. The elastic means 271 may include a pair of elastic means 271 spaced apart from each other. For example, the elastic means 271 may be contracted when the pressure unit 290 is lowered. Furthermore, when the pressure unit 290 is raised, the elastic means 271 may recover the connection member 270 to the original position by the recovery force. For example, the elastic means 271 may be a coil spring, but there is no separate limitation.

The pressure unit 290 is coupled to the connection member 270 and is configured to vacuum-adsorb the inserted current collecting plate 91. Furthermore, for example, a lower surface of the pressure unit 290 may vacuum-adsorb the current collecting plate 91. In other words, when a welding process is performed for the current collecting plate 91, vacuum environment may be created inside the pressure unit 290. At this point, the “vacuum environment” may have a pressure value lower than atmospheric pressure.

A through hole 291 is formed at one portion of the pressure unit 290, and a laser beam emitted from the laser output unit 90 may pass through the through hole 291 to weld the current collecting plate 91 on the jelly roll 93. For example, a welding pattern (not illustrated) is formed at the lowest portion of the pressure unit 290, and when the laser output unit 90 performs laser welding for the jelly roll 93 of the current collecting plate 91, the welding may be performed along the welding pattern. Herein, the welding pattern may be a welding attachment pattern formed with a single laser beam, and during the laser welding, a pattern size and shape formed by a pattern frame, a location, etc. may be changed according to welding conditions. Furthermore, the pressure unit 290 may further include a separate through hole 291 to detect the location of the current collecting plate 91 by the height detection unit 60.

Furthermore, the pressure unit 290 may include a contact member 293. The contact member 293 is formed at a portion of the pressure unit 290, for example, at a portion closest to the inserted current collecting plate 91, and fixes and/or presses the current collecting plate 91 on the jelly roll 93 while vacuum-adsorbing the current collecting plate 91. When the current collecting plate 91 is welded, the vacuum environment may be created inside the contact member 293.

Referring to FIG. 3, the encoder 30 may be a rotary encoder disposed at a portion adjacent to the driving device M. By the encoder 30, for example, at least one information of a group consisting of a rotation angle, a rotation speed, and the number of rotations of the driving device M and/or the rotating plate 10 may be known. Furthermore, when a reducer with a preset gear ratio (or reduction gear ratio) is disposed, it should be noted that a rotation angle of the driving device M and a rotation angle of the rotating plate 10 may be different from each other according to a gear ratio.

Furthermore, for example, when the encoder 30 is an absolute encoder, in addition to “multiple turn information” that is multiple turn information of the driving device M and/or the rotating plate 10, “single turn information” indicating that how much the driving device M was rotated within a single rotation range (between 0°˜360°) may be known. In detail, the single turn information indicates that how much a rotary motor was rotated within a single rotation range (between 0° and 360°), and the multiple turn information indicates that how much the rotary motor was rotated totally. Otherwise, the encoder 30 may be an incremental encoder, or both an absolute encoder and incremental encoder, and there is no separate limitation.

In addition, one encoder 30 or a plurality of encoders 30 may be formed at a portion adjacent to the driving device M. For convenience of the description, hereinbelow, the encoder 30 may be divided into a first encoder 310 and a second encoder 330, and it should be noted that a single encoder 30 may be formed if necessary.

Based on the information of the encoder 30, the scanner board 40 specifies a rotation speed of the rotating plate 10 and a location of the rotating plate 10 according to rotation (or a rotation angle from a preset point). For example, the scanner board 40 may count a pulse value of the first encoder 310 to specify a rotation speed of the driving device M and/or the rotating plate 10 and a rotation angle of the rotating plate 10. At this point, it may be preferable that the first encoder 310 is an incremental encoder, but there is no limitation.

The information about the specified rotation speed and angle of the scanner board 40 may be transferred or transmitted to the control unit P. Generally, when the rotating plate 10 rotated with the cam driving method is used, an acceleration section and/or a deceleration section may exist in rotation of the rotating plate 10. For example, the rotating plate 10 is rotated with acceleration for a predetermined time until the rotating plate 10 is rotated at a constant speed, and the rotating plate 10 is rotated with deceleration for a predetermined time until the rotating plate 10 stops after rotation of the constant speed.

In view of that, according to the embodiment of the present disclosure, the welding system of the present disclosure is characterized to specify the rotation speed and the rotation angle of the rotating plate 10 with the scanner board 40 and the first encoder 310 to perform precise welding for the current collecting plate 91 not only when the rotating plate 10 is rotated at a constant speed, but also when the rotating plate 10 is rotated with acceleration and/or deceleration. In other words, based on the rotation speed and the rotation angle at each time point of time of the rotating plate 10, the control unit P to be described below may correct the welding pattern information for the current collecting plate 91 to be welded according to the pre-stored welding pattern information.

The location detection unit 50 may be configured to specify a reference location and a rotation angle of the fixing jig 20 based on the information of the encoder 30 and, for example, the location detection unit 50 may be a cam position sensor. The location detection unit 50 may specify a rotation angle of the fixing jig 20 from the reference location based on the information of the second encoder 330. At this point, it may be preferable that the second encoder 320 is an absolute encoder, but there is no limitation.

When each fixing jig 20 forms a preset rotation angle from the reference location on the basis of the specified information of the location detection unit 50, the control unit P may control the laser output unit 90 so that the laser output unit 90 emits a laser beam to the current collecting plate 91. In other words, the laser beam emission time point of the laser output unit 90 may be controlled with the information output by the location detection unit 50, and the welding pattern information according to acceleration and/or deceleration of the rotating plate 10 may be corrected with the information output by the scanner board 40.

Referring to FIGS. 2 to 4, the height detection unit 60 is disposed above the rotating plate 10 and is configured to detect a position or a height of the current collecting plate 91 fixed on the jelly roll 93. The position or height information of the current collecting plate 91, the information being specified by the height detection unit 60, may be transferred to the control unit P to be described below. Furthermore, the height detection unit 60 is located above the rotating plate 10 and/or the pressure unit 290, and it is preferable to measure the height of the current collecting plate 91 fixed on the jelly roll 93 by the pressure unit 290. The height detection unit 60 may be securely installed at a preset point.

Furthermore, the height detection unit 60 is a displacement sensor and, for example, may be a non-contact displacement sensor such as an ultrasonic displacement sensor, a laser displacement sensor, an eddy-current displacement sensor, an optical displacement sensor, etc., and if necessary, may be a contact displacement sensor, but the scope of the present disclosure is not limited to the specific embodiment. Furthermore, the height detection unit 60 is preferably disposed at a position before the current collecting plate 91 is inserted into the laser output unit 90, in a rotation direction of the rotating plate 10.

FIG. 6 is a reference view illustrating a sensor dog and a sensor dog detection unit according to FIG. 3.

Referring to FIGS. 2 to 4, and 6, the sensor dog 70 is disposed on the rotating plate 10 and is a detection object of the sensor dog detection unit 80. A plurality of the sensor dogs 70 is preferably disposed on the rotating plate 10 and further preferably spaced apart from each other at a substantially equal angle in a circumferential direction. Furthermore, a number of sensor dogs 70 may be formed equally to the number of fixing jigs 20. For example, each sensor dog 70 may be installed at a portion of each fixing jig 20 or a portion adjacent to each fixing jig 20, or a portion between a pair of fixing jigs 20 adjacent to each other. Shapes and forms of the sensor dog 70 are not limited particularly.

The sensor dog detection unit 80 is disposed at a position spaced apart from the rotating plate 10 and configured to detect each sensor dog 70 installed at the rotating plate 10 rotated. For example, the sensor dog detection unit 80 may be one of different types of sensors such as an optical sensor, ultrasonic sensor, etc., and the scope of the present disclosure is not limited to the specific embodiment. As described above, the plurality of fixing jigs 20 is spaced apart from each other at a substantially equal angle in the circumferential direction, and the plurality of sensor dogs 70 is also spaced apart from each other at a substantially equal angle in the circumferential direction.

Therefore, when the sensor dog detection unit 80 detects the adjacent sensor dog 70, it may be specified that the fixing jig 20 to which the current collecting plate 91 and the jelly roll 93 are fixed is inserted toward the laser output unit 90. Specifically, when each sensor dog 70 is disposed at a position of each fixing jig 20 or at a portion adjacent to the fixing jig 20, and when the sensor dog 70 at the fixing jig 20 is detected by the sensor dog detection unit 80, it may be specified that another fixing jig 20 is inserted into the laser output unit 90. At this point, the control unit P controls the laser output unit 90 to emit a laser beam. As an example, the sensor dog detection unit 80 is disposed below the laser output unit 90, so the sensor dog detection unit 80 may detect the sensor dog 70 inserted toward the laser output unit 90 but the scope of the present disclosure is not limited thereto.

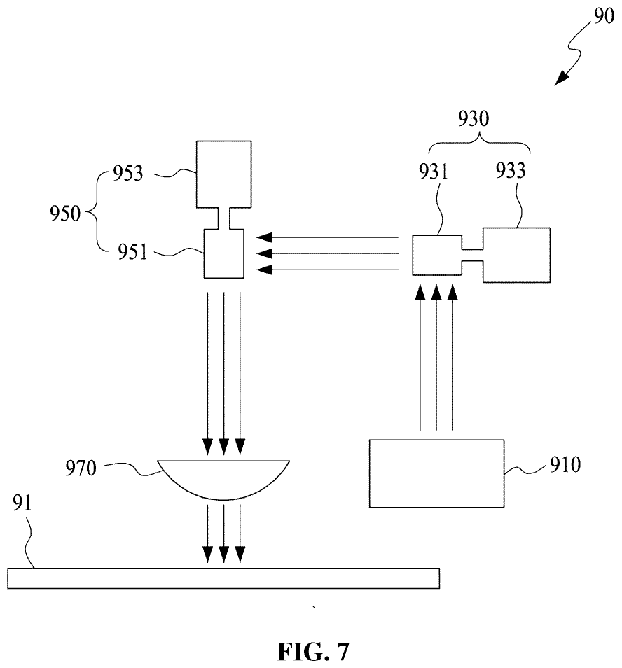

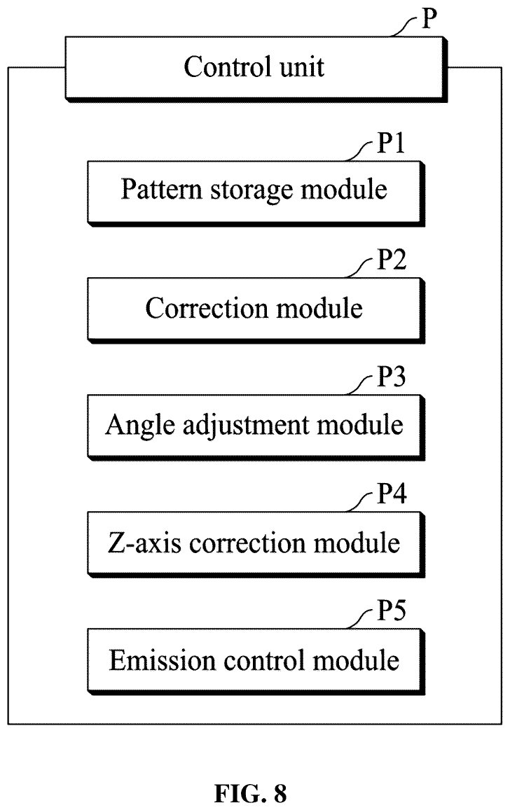

FIG. 7 is a concept view illustrating a laser output unit according to FIG. 2.

Referring to FIGS. 2 to 4, 7, the laser output unit 90 is spaced apart from the rotating plate 10 and each fixing jig 20 and is configured to laser-weld the current collecting plate 91 fixed by the fixing jig 20 and inserted. As described above, it is preferable that the rotating plate 10 maintains a rotated state thereof even when the current collecting plate 91 and the jelly roll 93 are welded. Therefore, the laser output unit 90 may track and weld the current collecting plate 91 rotated in real time. When welding the current collecting plate 91 on the jelly roll 93, the laser output unit 90 may laser-weld the current collecting plate 91 rotated together with the rotating plate 10 within a predetermined angle range. In other words, the laser output unit 90 may track and weld the current collecting plate 91 within the predetermined angle range preset according to a rotation direction of the rotating plate 10. Furthermore, the laser output unit 90 may include a scanner or a galvanometer (galvo) which is a sophisticated mechanical device generating or reflecting light.

To this end, the laser output unit 90 may include a light source apparatus 910, a first scanner 930, a second scanner 950, and an optical lens 970.

The light source apparatus 910 may be configured to generate and emit a laser beam.

The first scanner 930 is configured to adjust a displacement of a first direction of the laser beam emitted from the light source apparatus 910. The first scanner 930 may include a first reflective mirror 931 and a first driving unit 933. The first reflective mirror 931 is rotatably installed to reflect the laser beam emitted from the light source apparatus 910. In addition, the first driving unit 933 is connected to one portion of the first reflective mirror 931 and configured to rotate the first reflective mirror 931.

The second scanner 950 is configured to adjust a displacement of a second direction of the laser beam reflected from the first scanner 930. It may be understood that the second direction is different from the first direction. The second scanner 950 may include a second reflective mirror 951 and a second driving unit 953. The second reflective mirror 951 is rotatably installed to reflect the laser beam reflected from the first reflective mirror 931. Furthermore, the second driving unit 953 is connected to one portion of the second reflective mirror 951 and configured to rotate the second reflective mirror 951.

The optical lens 970 is disposed between the second scanner 950 and the inserted current collecting plate 91.

FIG. 8 is a block diagram illustrating a control unit according to FIG. 2.

Referring to FIGS. 2 to 4, and 8, the control unit P is configured to control an emitting condition of a laser beam of the laser output unit 90. In addition, for example during laser welding, the control unit P may track a location of the current collecting plate 91 rotated together with the fixing jig 20 and control the laser output unit 90. For example, the control unit P may confirm a two-dimensional location information of the current collecting plate 91 to adjust an angle of the reflective mirror 931, 951 to allow laser welding of the current collecting plate 91 for the jelly roll 93.

As an example, during laser welding, the control unit P calculates a location of the current collecting plate 91 on the basis of a rotation speed of the rotating plate 10, and according to a real time location of the current collecting plate 91, the control unit P may control the pair of scanners 930 and 950 to adjust an angle of the reflective mirror 931, 951 by the driving unit 933, 953, but the scope of the present disclosure is not limited thereto.

With the above-described method, while the rotating plate 10 maintains the rotated state thereof without stop of the rotating plate 10, the current collecting plate 91 may be welded to the jelly roll 93. Therefore, according to the embodiment of the present disclosure, the welding system of the present disclosure is characterized in that a relatively large number of laser welding processes can be performed within the equal amount of time.

The control unit P may include a pattern storage module P1, a correction module P2, an angle adjustment module P3, a Z-axis correction module P4, and an emission control module P5.

The pattern storage module P1 is configured to store the welding pattern information about the current collecting plate 91. At this point, in the “welding pattern information”, one or more information such as a location (e.g., pattern coordinate value), a size, and a shape of the laser beam welding pattern actually applied to the current collecting plate 91 are preset.

The correction module P2 is configured to calculate the corrected welding pattern information on the basis of the welding pattern information transferred from the pattern storage module P1. The corrected welding pattern information may be time series information. For example, based on the welding pattern information, the correction module P2 may calculate the real time-corrected welding pattern information of the current collecting plate 91 considering a rotation speed of the rotating plate 10, but the scope of the present disclosure is not limited thereto. With the correction module P2, the welding pattern information stored in the pattern storage module P1 may be corrected considering the rotation speed of the rotating plate 10.

As an example, based on the information about the rotation speed and/or the rotation angle of the rotating plate 10 specified by the scanner board 40, the correction module P2 corrects the welding pattern information at each time point, thereby allowing the rotated current collecting plate 91 to be welded into a form, a size, and/or a shape corresponding to the pattern information stored in the pattern storage module P1. As described above, the welding pattern information is corrected based on the rotation speed and/or the rotation angle of the rotating plate 10 so that the laser beam may be emitted to the current collecting plate 91 to correspond to the substantial welding pattern information stored in the pattern storage module P1.

Furthermore, the correction module P2 may correct laser density at each time point on the basis of the rotation speed of the rotating plate 10 specified by the scanner board 40. Herein, it is understood that the “laser density” is total amount of energy applied per unit area by a laser beam. For example, the correction module P2 corrects to increase the laser density in a section where the rotating plate 10 accelerates, and corrects to reduce the laser density in a section where the rotating plate 10 decelerates. Accordingly, the laser output unit 90 may emit a laser beam at the corresponding laser density.

The angle adjustment module P3 is configured to control an angle of the reflective mirror (“first reflective mirror 931” or “second reflective mirror 951”) of the scanner 930, 950 on the basis of the welding pattern information corrected by the correction module P2. For example, the angle adjustment module P3 may control the driving unit (“first driving unit 933” or “second driving unit 953”) of the scanner 930, 950 to adjust an angle of the reflective mirror. The angle adjustment module P3 may control the laser output unit 90 to track the current collecting plate 91 and perform laser welding in consideration of a distance and an angle between the laser output unit 90 and the current collecting plate 91.

The Z-axis correction module P4 is configured to correct the height of the laser output unit 90 on the basis of the height information of the current collecting plate 91 detected by the height detection unit 60. For example, when the height of the current collecting plate 91 is higher than an upper limit value and a lower limit value having ±allowable values in comparison to a preset reference value, the Z-axis correction module P4 may correct the height of the laser output unit 90, and when the height of the current collecting plate 91 is within the range between the upper limit value and the lower limit value, the Z-axis correction module P4 may not correct the height of the laser output unit 90, but the scope of the present disclosure is not limited thereto. As described above, as the height of the laser output unit 90 is corrected before welding of the current collecting plate 91, welding uniformity of the current collecting plate 91 can be secured without changing the laser emitting condition, etc.

The emission control module P5 is configured to control a time point of emitting a laser beam to the laser output unit 90. With the information specified by the location detection unit 50, when the fixing jig 20 forms the preset rotation angle from the reference location, the emission control module P5 may control the laser beam to be emitted to the laser output unit 90. Otherwise, when the sensor dog detection unit 80 detects the adjacent sensor dog 70, the emission control module P5 may control the laser beam to be emitted to the laser output unit 90.

FIG. 9 is a flowchart illustrating a method for welding a current collecting plate for a secondary battery cell according to an embodiment of the present disclosure.

Hereinbelow, a current collector welding method S1 for a secondary battery cell according to an embodiment of the present disclosure will be described in detail with reference to accompanying drawings. It should be noted that each step described below may be performed in a different time series order than described below.

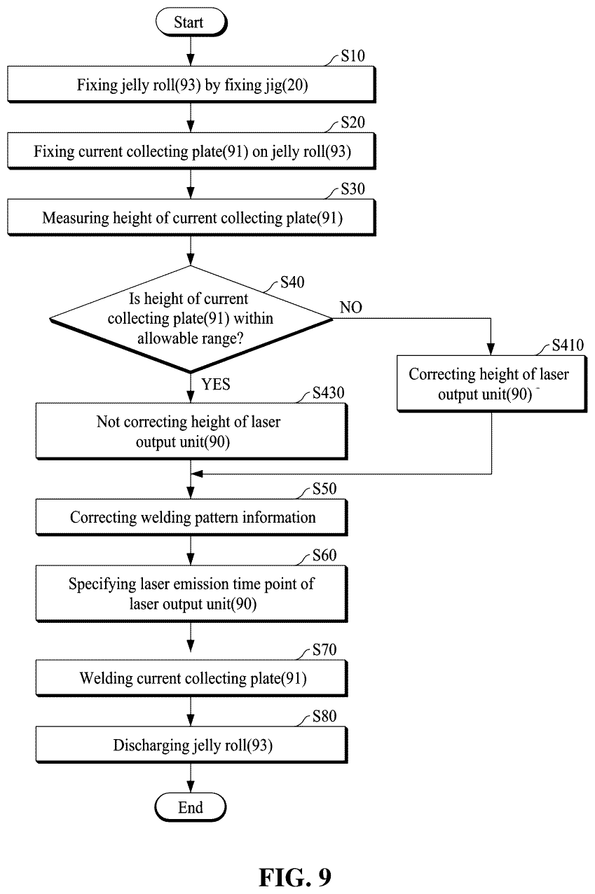

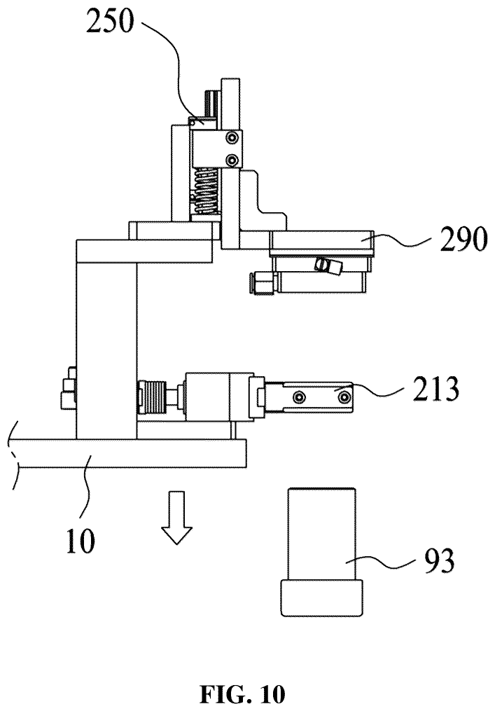

FIG. 10 is a reference view illustrating step S10 according to FIG. 9. FIG. 11 is a reference view illustrating step S20 according to FIG. 9.

Referring to FIGS. 9 and 10, first, the jelly roll 93 inserted when the rotating plate 10 is lowered is fixed by the fixing jig 20 at S10. Thereafter, the rotating plate 10 may be rotated in one direction.

Referring to FIGS. 9 and 11, while vacuum-adsorbing the inserted current collecting plate 91, the pressure unit 290 is lowered by the raising and lowering means 250. At the same time, while fixing the jelly roll 93, the gripper unit 213 may be raised with the rotating plate 10 to fix and press the current collecting plate 91 on the jelly roll 93 at S20. Each of the step S10 and the step S20 may be performed at the different time series order.

Referring to FIG. 9, thereafter, the height detection unit 60 is transferred and so that the height of the current collecting plate 91 on the jelly roll 93 inserted toward the height detection unit 60 may be measured at S30. The height information of the current collecting plate 91 measured at S30 may be transferred to the control unit P.

Thereafter, the control unit P may determine whether the height of the current collecting plate 91 to be welded is within the allowable range, at S40. At S40, when the height of the current collecting plate 91 is higher than the allowable range, the control unit P corrects the height of the laser output unit 90 at S410, and when the height is not within the allowable range, the control unit P does not correct the height of the laser output unit 90 at S430.

Furthermore, before or after S40, the welding pattern information may be corrected under the control of the control unit P at S50. S60 may be performed by the correction module P2.

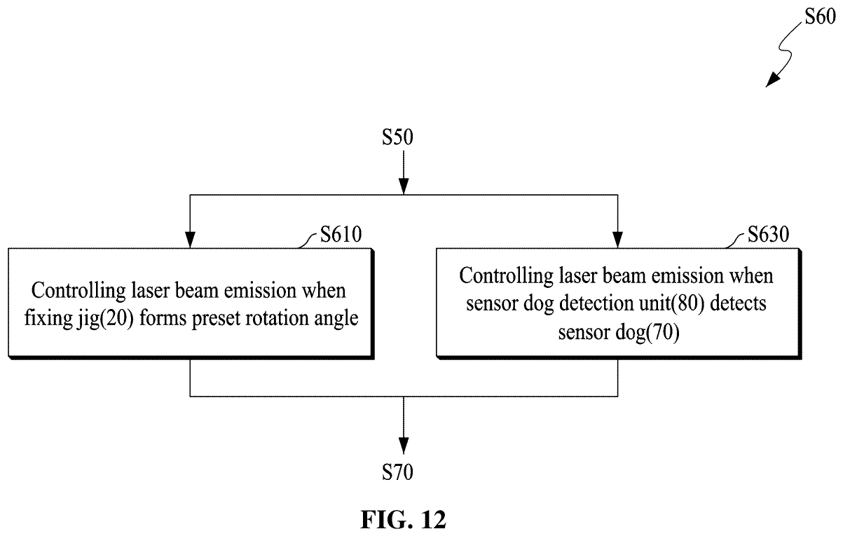

FIG. 12 is a concept view illustrating step S60 according to FIG. 9.

Referring to FIGS. 9 and 12, a laser emission time point of the laser output unit 90 may be specified with the follow process at S60. At S60, for example, with the information specified by the location detection unit 50, when the fixing jig 20 forms the preset rotation angle from the reference location, the correction module may control the laser beam to be emitted to the laser output unit 90 at S610. Otherwise, at S60, when the sensor dog detection unit 80 detects the adjacent sensor dog 70, the correction module may control the laser beam to be emitted to the laser output unit 90 at S630.

Referring to FIG. 9, thereafter, the laser output unit 90 may weld the inserted current collecting plate 91 on the jelly roll 93 at S70. At S70, the laser output unit 90 may weld the current collecting plate 91 in consideration of the rotation speed and/or the rotation angle of the rotating plate 10 specified by the encoder 30 and the scanner board 40. Based on the welding pattern information stored in the pattern storage module P1 and the welding pattern information corrected by the laser correction module P2, the welding S70 may be performed by controlling an angle of the reflective mirror (“first reflective mirror 931” or “second reflective mirror 951”) of the scanner 930, 950.

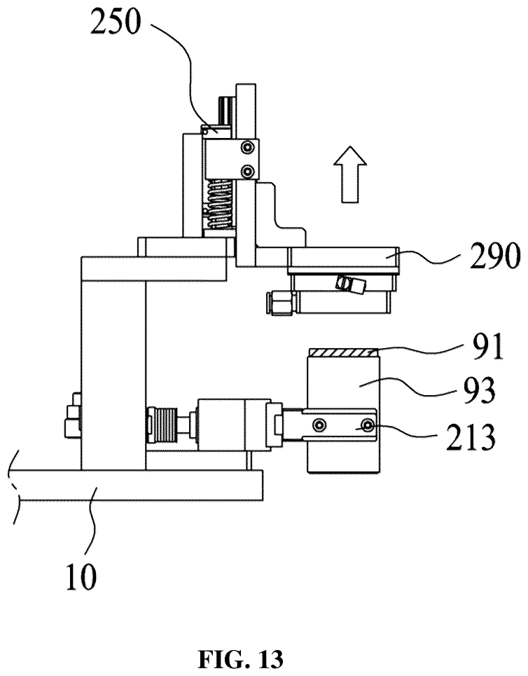

FIG. 13 is a concept view illustrating step S80 according to FIG. 9.

Referring to FIGS. 9 and 13, finally, the raising and lowering means 250 moves the pressure unit 290 vertically to discharge the jelly roll 93 where welding of the current collecting plate 91 is completed, at S80.

The detailed description above is illustrative of the present disclosure. The above detailed description is illustrative of the present disclosure. In addition, the above description shows and describes preferred embodiments of the present disclosure, and the present disclosure can be used in various other combinations, modifications, and environments. In other words, changes or modifications are possible within the scope of the concept of the disclosure disclosed herein, the scope equivalent to the written disclosure, and/or within the scope of skill or knowledge in the art. The above-described embodiments describe the best state for implementing the technical spirit of the present disclosure, and various changes required in the specific application field and use of the present disclosure are possible. Accordingly, the detailed description of the present disclosure is not intended to limit the present disclosure to the disclosed embodiments.

What is claimed is:

1. A current collector welding system for a secondary battery cell, the current collector welding system comprising:
a rotating plate rotated by a driving device;
a fixing jig coupled to the rotating plate and fixing a current collecting plate on a jelly roll;
a laser output unit spaced apart from the rotating plate and configured to laser welding the current collecting plate to one portion of the inserted jelly roll; and
a control unit controlling the laser output unit,
wherein the laser output unit tracks and welds the current collecting plate rotated with the rotating plate.

2. The current collector welding system of claim 1, wherein the laser output unit laser-welds the current collecting plate rotated with the rotating plate within a predetermined angle range when the current collecting plate is welded on the jelly roll.

3. The current collector welding system of claim 1, wherein the laser output unit comprises:
a light source apparatus emitting a laser beam;
a first scanner controlling a first directional displacement of the laser beam emitted from the light source apparatus; and
a second scanner controlling a second directional displacement of the laser beam reflected from the first scanner.

4. The current collector welding system of claim 1, wherein the first scanner comprises:
a first reflective mirror provided to be rotatable to reflect a laser beam emitted from the light source apparatus; and
a first driving unit connected to the first reflective mirror and rotating the first reflective mirror.

5. The current collector welding system of claim 4, wherein the second scanner comprises:
a second reflective mirror provided to be rotatable to reflect the laser beam reflected from the first scanner; and
a second driving unit connected to the second reflective mirror and rotating the second reflective mirror.

6. The current collector welding system of claim 1, further comprising:
an encoder disposed adjacent to the rotating plate; and
a scanner board specifying a rotation speed of the rotating plate on the basis of information acquired from the encoder.

7. The current collector welding system of claim 6, wherein the laser output unit comprises:
a light source apparatus emitting a laser beam;
a first scanner controlling a first directional displacement of the laser beam emitted from the light source apparatus; and
a second scanner controlling a second directional displacement of the laser beam reflected from the first scanner, and
the control unit comprises:
a pattern storage module storing welding pattern information for the current collecting plate;
a correction module calculating corrected welding pattern information, which is time series information, on the basis of the welding pattern information by considering a rotation speed of the rotating plate; and
an angle adjustment module controlling the first scanner and the second scanner to follow the welding pattern information corrected by the correction module.

8. The current collector welding system of claim 7, wherein the correction module is configured to further correct laser density at each time point on the basis of the rotation speed of the rotating plate specified by the scanner board.

9. The current collector welding system of claim 1, further comprising:
an encoder specifying a rotation speed of the rotating plate; and
a location detection unit specifying a rotation angle between a reference location at a specific time point and the fixing jig on the basis of information acquired from the encoder.

10. The current collector welding system of claim 9, wherein the control unit comprises an emission control module, and when the preset rotation angle is formed between the reference location at the specific time point and the fixing jig, the emission control module controls the laser output unit to emit the laser beam.

11. The current collector welding system of claim 1, further comprising:
a height detection unit located on the rotating plate, and detecting a height of the current collecting plate fixed by the fixing jig,
wherein the laser output unit is configured to be raised and lowered, and
the control unit comprises:
a Z-axis correction module correcting a height of the laser output unit on the basis of the height information of the current collecting plate detected by the height detection unit.

12. The current collector welding system of claim 11, wherein the height detection unit is a displacement sensor.

13. The current collector welding system of claim 11, wherein the Z-axis correction module corrects a Z-axis coordinate value of the laser output unit when the height of the current collecting plate exceeds an upper limit value and a lower limit value having ±permissible value based on a reference value.

14. The current collector welding system of claim 1, further comprising:
a sensor dog disposed on the rotating plate; and
a sensor dog detection unit fixed to one side and detecting the sensor dog rotated with the rotating plate,
wherein the control unit comprises:
an emission control module controlling the laser output unit to emit a laser beam when the sensor dog detection unit detects the sensor dog.

15. The current collector welding system of claim 14, wherein the sensor dog is disposed to be spaced apart from another sensor dog at a substantially equal angle in a circumferential direction.

16. The current collector welding system of claim 15, wherein each sensor dog is disposed a portion of the corresponding fixing jig or a portion adjacent to the fixing jig.

17. A current collector welding system for a secondary battery cell, the current collector welding system comprising:
a rotating plate rotated by a driving device;
a plurality of fixing jigs coupled to the rotating plate, fixing a current collecting plate on a jelly roll, and spaced apart from each other in a circumferential direction;
a laser output unit spaced apart from the rotating plate, and laser welding the current collecting plate at one portion of the jelly roll that is inserted with rotation of the rotating plate; and
a control unit controlling the laser output unit,
wherein the laser output unit tracks and welds the current collecting plate, which is rotated with the rotating plate, within a predetermined angle range, and
the rotating plate maintains a rotated state thereof during welding of the current collecting plate.

18. The current collector welding system of claim 17, wherein each fixing jig comprises:
a fixing unit coupled to the rotating plate and fixing the jelly roll inserted;
a raising and lowering means controlling raising and lowering of a pressure unit; and
the pressure unit vacuum-adsorbing the inserted current collecting plate and fixing the current collecting plate on the jelly roll.

19. The current collector welding system of claim 18, wherein the pressure unit comprises a through hole providing a passage through which a laser beam emitted from the laser output unit reaches the current collecting plate.

20. The current collector welding system of claim 17, further comprising:
an encoder disposed adjacent to the rotating plate; and
a scanner board specifying a rotation speed of the rotating plate on the basis of information acquired from the encoder,
wherein the control unit comprises:
a pattern storage module storing welding pattern information about the current collecting plate;
a correction module calculating corrected welding pattern information on the basis of the welding pattern information by considering a rotation speed of the rotating plate; and
an angle adjustment module controlling the first scanner and the second scanner to follow the welding pattern information corrected by the correction module, and
the scanner board counts a pulse value of the encoder and specifies a rotation speed of the rotating plate.
